(19) United States
(12) Patent Application Publication
(10) Pub. No.: US 2014/0085585 A1
(43) Pub. Date: Mar. 27, 2014

(54) DISPLAY PANEL HAVING LARGER DISPLAY AREA AND METHOD OF MANUFACTURING THE SAME

(71) Applicant: SAMSUNG DISPLAY CO., LTD., Yongin-City (KR)

(72) Inventors: Woo Yong SUNG, Seoul (KR); Jeongho LEE, Seoul (KR); Taewoon CHA, Seoul (KR); Sang Youn HAN, Seoul (KR)

(73) Assignee: SAMSUNG DISPLAY CO., LTD., Yongin-City, Gyeonggi-Do (KR)

(21) Appl. No.: 13/794,069

(22) Filed: Mar. 11, 2013

(30) Foreign Application Priority Data
Sep. 21, 2012 (KR) 10-2012-0105400

(51) Int. Cl. G02F 1/1345

(52) U.S. Cl. CPC G02F 1/13458
USPC 349/143; 445/25

(57) ABSTRACT

A display apparatus includes an array substrate that includes a display area including a pixel and a non-display area adjacent to the display area, an opposite substrate facing the array substrate, a liquid crystal layer disposed between the array substrate and the opposite substrate, and a signal input pad electrically connected to the pixel to apply an external input signal to the pixel. Each of the array substrate and the opposite substrate has an inner surface facing the liquid crystal layer and an outer surface opposite to the respective inner surface, and the signal input pad is disposed on the outer surface of either the array substrate or the opposite substrate.

### CROSS-REFERENCE TO RELATED APPLICATION

This U.S. non-provisional patent application claims priority under 35 U.S.C. §119 to Korean Patent Application No. 10-2012-0105400, filed on Sep. 21, 2012, the content of which is herein incorporated by reference.

### BACKGROUND

1. Field of Disclosure

The present disclosure relates generally to flat panel displays. More particularly, the present disclosure relates flat panel displays with larger display areas, and methods of their manufacture.

2. Description of the Related Art

In general, a display apparatus includes a display panel displaying an image, and an external circuit module applying various control signals to the display panel, where the display panel and the external circuit module are fixed to a receiving container such as a chassis. In addition, the display panel and the external circuit module are connected to each other through signal lines disposed on what is typically a signal transmission member, e.g., a tape carrier package or a flexible printed circuit board.

Accordingly, the display panel is required to allocate an area used to connect the display panel and the signal lines, and the receiving container is required to provide a predetermined space in which the signal lines are accommodated. Therefore, in recent years, efforts have been taken to develop methods of reducing the area in which the image is not displayed.

### SUMMARY

The present disclosure provides a display panel capable of reducing a non-display area.

The present disclosure provides a method of manufacturing such a display panel.

Embodiments of the inventive concept provide a display panel includes an array substrate that includes a display area including a pixel and a non-display area adjacent to the display area, an opposite substrate facing the array substrate, a liquid crystal layer disposed between the array substrate and the opposite substrate, and a signal input pad electrically connected to the pixel so as to be configured to apply an external input signal to the pixel. Each of the array substrate and the opposite substrate has an inner surface facing the liquid crystal layer and an outer surface opposite to the respective inner surface, and the signal input pad is disposed on the outer surface of either the array substrate or the opposite substrate.

The display panel further includes a connection line connecting the signal line and the signal input pad.

The array substrate includes a first base substrate disposed over the display area and the non-display area and including an upper surface facing the opposite substrate, a lower surface opposite to the upper surface, and a side surface connecting the upper surface and the lower surface, a thin film transistor disposed on the upper surface of the first base substrate in the non-display area, a pixel electrode connected to the thin film transistor, and a signal line connected to the thin film transistor, extending into the non-display area, and electrically connected to the signal input pad.

The signal input pad is disposed on the lower surface of the first base substrate.

The connection line includes a first portion in electrical communication with the signal line, a second portion connected to the first portion and disposed on the side surface of the first base substrate, and a third portion disposed on the lower surface of the first base substrate to connect the second portion and the signal input pad. The opposite substrate has a surface area equal to or greater than a surface area of the array substrate.

The opposite substrate includes a second base substrate disposed over the display area and the non-display area and including a lower surface facing the array substrate, an upper surface opposite to the lower surface, and a side surface connecting the upper surface and the lower surface, and a common electrode disposed on the lower surface of the second base substrate.

The signal input pad is disposed on the upper surface of the second base substrate.

The display panel further includes a seal pattern disposed in the non-display area to surround the display area and to electrically couple the array substrate to the opposite substrate.

The connection line includes a fourth portion electrically connected to the signal line, a fifth portion connected to the fourth portion and disposed on an outer surface of the seal pattern, a sixth portion connected to the fifth portion and disposed on the lower surface of the second base substrate, a seventh portion connected to the sixth portion and disposed on the side surface of the second base substrate, and an eighth portion disposed on the upper surface of the second base substrate to connect the seventh portion and the signal input pad. The opposite substrate has a surface area equal to or smaller than that of the array substrate.

Embodiments of the inventive concept provide a method of manufacturing a display panel that includes preparing an array substrate having a display area and a non-display area adjacent to the display area, coupling an opposite substrate to the array substrate using a seal pattern disposed in the non-display area, the opposite substrate being disposed over the display area and the non-display area, and forming a signal input pad electrically connected to the signal line. Each of the array substrate and the opposite substrate has an inner surface facing the seal pattern and an outer surface opposite to the respective inner surface, and the signal input pad is disposed on the outer surface of either the array substrate or the opposite substrate. The array substrate includes a first base substrate, a thin film transistor disposed on the first base substrate in the display area, and a signal line connected to the thin film transistor and extending into the non-display area

The display panel further includes a connection line electrically connecting the signal line to the signal input pad, and the signal input pad and the connection line are formed by using an aerosol jet method.

According to the above, the area of the display panel outside the display area, in which the image is displayed, may be reduced. Thus, the non-display area of the display device employing the display panel may be reduced, and the display area may be enlarged.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing a display apparatus according to an exemplary embodiment of the present invention;

FIG. 2 is a lower perspective view showing a display panel shown in FIG. 1;

FIG. 3 is a partially enlarged view showing a portion A of FIG. 2;

FIG. 4 is a plan view showing the display panel shown in FIG. 2;

FIG. 5 is a partially enlarged view showing a portion B of FIG. 4;

FIG. 6 is a rear plan view showing the display panel shown in FIG. 2;

FIG. 7 is a partially enlarged view showing a portion C of FIG. 6;

FIG. 8 is a lower perspective view showing a connection state between the display panel shown in FIG. 2 and a flexible printed circuit board;

FIG. 9 is a cross-sectional view showing a portion of the display panel shown in FIG. 8;

FIGS. 10 to 13 are cross-sectional views explaining a method of manufacturing the display panel shown in FIGS. 8 and 9;

FIG. 14 is a perspective view showing a display panel according to another exemplary embodiment of the present invention;

FIG. 15 is a partially enlarged view showing a portion D of FIG. 14;

FIG. 16 is a plan view showing the display panel shown in FIG. 14;

FIG. 17 is a partially enlarged view showing a portion E of FIG. 16;

FIG. 18 is a perspective view showing a connection state between the display panel shown in FIG. 14 and a flexible printed circuit board;

FIG. 19 is a cross-sectional view showing the display panel shown in FIG. 18; and

FIGS. 20 to 22 are cross-sectional views explaining a method of manufacturing the display panel shown in FIGS. 18 and 19.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

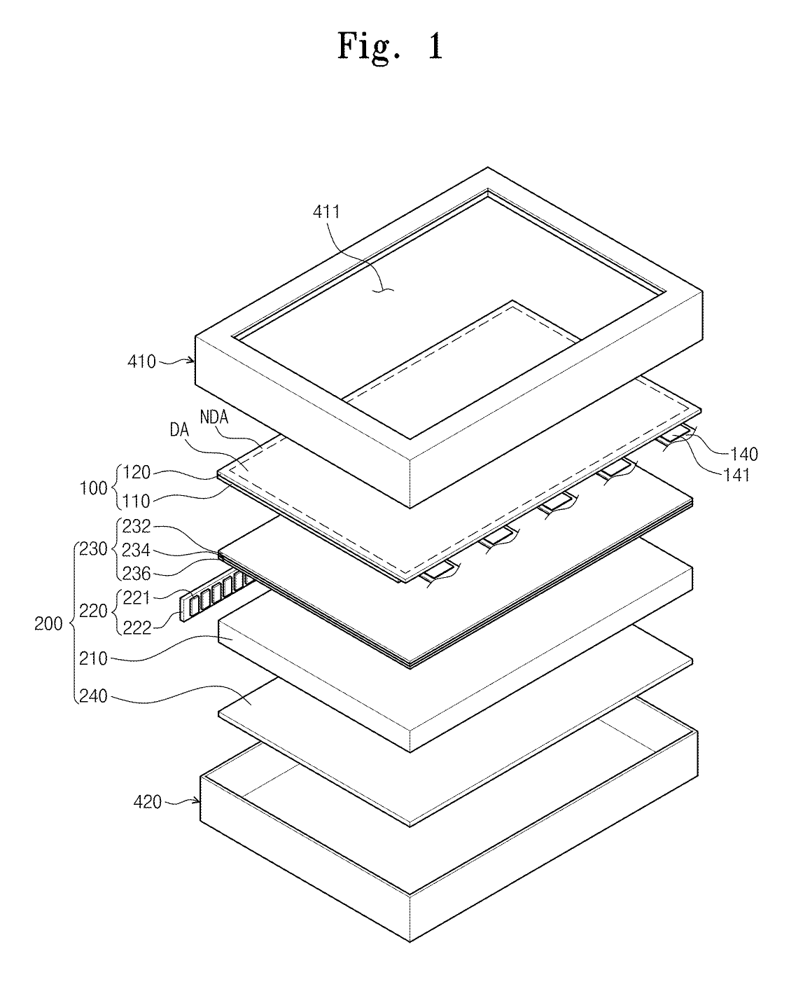

FIG. 1 is an exploded perspective view showing a display apparatus according to an exemplary embodiment of the present invention.

Referring to FIG. 1, a display apparatus includes a display panel 100, a backlight unit 200, an upper cover 410, and a lower cover 420.

The display panel 100 may be any type of display panel, such as a liquid crystal display panel, an electrophoretic display panel, an electrowetting display panel, etc. In the present exemplary embodiment, as a representative example, a liquid crystal display panel will be described as the display panel.

The display panel 100 has a rectangular shape with long sides and short sides, and includes a display area DA in which an image is displayed and a non-display area NDA disposed adjacent to, and surrounding, the display area DA. In addition, the display panel 100 includes an array substrate 110, an opposite substrate 120 facing the array substrate 110, and a liquid crystal layer (not shown) interposed between the array substrate 110 and the opposite substrate 120. The display panel 100 further includes polarizing plates (not shown) respectively attached to its outer surfaces, i.e., an outer surface of the array substrate 110 and an outer surface of the opposite substrate 120.

The array substrate 110 includes a plurality of pixels (not shown) arranged in the display area DA in a matrix arrangement. Each pixel includes a plurality of sub-pixels having different colors. For instance, each sub-pixel can have a red, green, or blue color. Thus, a light exiting from each sub-pixel takes on one of the red, green, or blue colors. In addition, each pixel includes a gate line (not shown), a data line (not shown) insulated from the gate line while crossing the gate line, and a pixel electrode (not shown). Further, each pixel includes a thin film transistor (not shown) electrically connected to the gate line, the data line, and the pixel electrode. The thin film transistor switches a driving signal applied to the pixel electrode.

A seal pattern (not shown) is disposed in the non-display area of the array substrate 110 to couple the array substrate 110 to the opposite substrate 120.

The opposite substrate 120 includes color filters (not shown), each of which realizes a predetermined color using the light provided from the backlight unit 200, and a common electrode (not shown) disposed on the color filters to face the pixel electrode. In this embodiment, each color filter has one of red, green, or blue colors, and is formed by a deposition or coating process. Meanwhile, in the present exemplary embodiment, the color filters are disposed on the opposite substrate 120, but they should not be limited thereto or thereby. That is, the color filters may instead be disposed on the array substrate 110.

The liquid crystal layer includes liquid crystal molecules arranged in a specific direction in response to an electric field generated by voltages respectively applied to the pixel electrode and the common electrode, and thus the liquid crystal layer controls a transmittance of the light passing through the liquid crystal molecules, thereby displaying desired images.

Meanwhile, in the non-display area NDA, a signal input pad (not shown) is disposed on an outer surface of the array substrate 110 or the opposite substrate 120. The signal input pad is connected to a flexible printed circuit board 140 on which a driver IC 141 is mounted, and the flexible printed circuit board 140 is connected to an external circuit module (not shown). The driver IC 141 has applied thereto various control signals from the external circuit module, and applies a driving signal to the display panel 100 in response to the various control signals.

The backlight unit 200 is disposed behind the display panel 100. The backlight unit 200 includes a light guide plate 210, a light source unit 220 including a plurality of light sources, an optical member 230, and a reflective sheet 240.

The light guide plate 210 is disposed under the display panel 100 and guides the light emitted from the light source unit 220 to the display panel 100. Particularly, the light guide plate 210 is overlapped with at least the display area DA of the display panel 100. The light guide plate 210 includes an exit surface from which the light exits, a lower surface facing the exit surface, and side surfaces connecting the exit surface and the lower surface. At least one of the side surfaces faces the light source unit 220 to serve as a light incident surface onto which the light emitted from the light source unit 220 is incident, and a side surface facing the light incident surface serves as a light reflective surface to reflect the light.

The light source unit 220 includes a printed circuit board 222 and the light sources 221, e.g., light emitting diodes, mounted on the printed circuit board 222.

Here, the light sources 221 may emit light having the same color, e.g., a white light.

In addition, different light sources 221 may emit light having different colors. In detail, in one embodiment, a portion of the light sources 221 emits a red light, a portion of the light sources 221 emits a green light, and a remaining portion of the light sources 221 emits a blue light.

The light source unit 220 is disposed to emit light while facing at least one side surface of the light guide plate 210, and provides the light to the display panel 100 through the light guide plate 210.

The optical member 230 is disposed between the light guide plate 210 and the display panel 100. The optical member 230 helps direct the light exiting through the light guide plate 210 from the light source unit 220. In addition, the optical member 230 includes a diffusion sheet 236, a prism sheet 234, and a protective sheet 232, which are sequentially stacked one on another.

The diffusion sheet 236 diffuses the light exiting from the light guide plate 210. The prism sheet 234 condenses the light diffused by the diffusion sheet 236 to allow the light to travel in a direction substantially vertical to the display panel 100. The light exiting from the prism sheet 234 is vertically incident onto the display panel 100. The protective sheet 232 is disposed on the prism sheet 234 to protect the prism sheet 234 from external impact.

In the present exemplary embodiment, the optical member 230 includes one diffusion sheet 236, one prism sheet 234, and one protective sheet 232, but it should not be limited thereto or thereby. That is, at least one of the diffusion sheet 236, the prism sheet 234, and the protective sheet 232 of the optical member 230 may be provided in plural number, or one of the diffusion sheet 236, the prism sheet 234, and the protective sheet 232 may be omitted from the optical member 230.

The reflective sheet 240 is disposed under the light guide plate 210 and reflects the light that leaks from the light guide plate without being directed to the display panel 100, to direct this leaked light up to the display panel 100. The reflective sheet 240 includes a light reflective material to reflect the light. The reflective sheet 240 is disposed on the lower cover 420 and reflects the light emitted from the light source unit 220. As a result, the reflective sheet 240 increases an amount of the light provided to the display panel 100.

In the present exemplary embodiment, the light source unit 220 is disposed to provide light to the side surface of the light guide plate 210, but it should not be limited thereto or thereby. That is, the light source unit 220 may be disposed to provide light to a lower surface of the light guide plate 210. In addition, in a case that the light guide plate 210 is omitted from the backlight unit 200, the light source unit 220 may be disposed under the display panel 100, and thus the light emitted from the light source unit 220 may be directly provided to the display panel 100.

The upper cover 410 is disposed on the display panel 100. The upper cover 410 is provided with a display window 411 formed therethrough to expose the display area DA of the display panel 100. The upper cover 410 is coupled with the lower cover 420 to support a front edge portion of the display panel 100.

The lower cover 420 is disposed under the backlight unit 200. The lower cover 420 provides a space to accommodate the display panel 100 and the backlight unit 200 therein. In addition, the lower cover 420 is coupled with the upper cover 410 to form a volume that accommodates the display panel 100 and the backlight unit 200 therein.

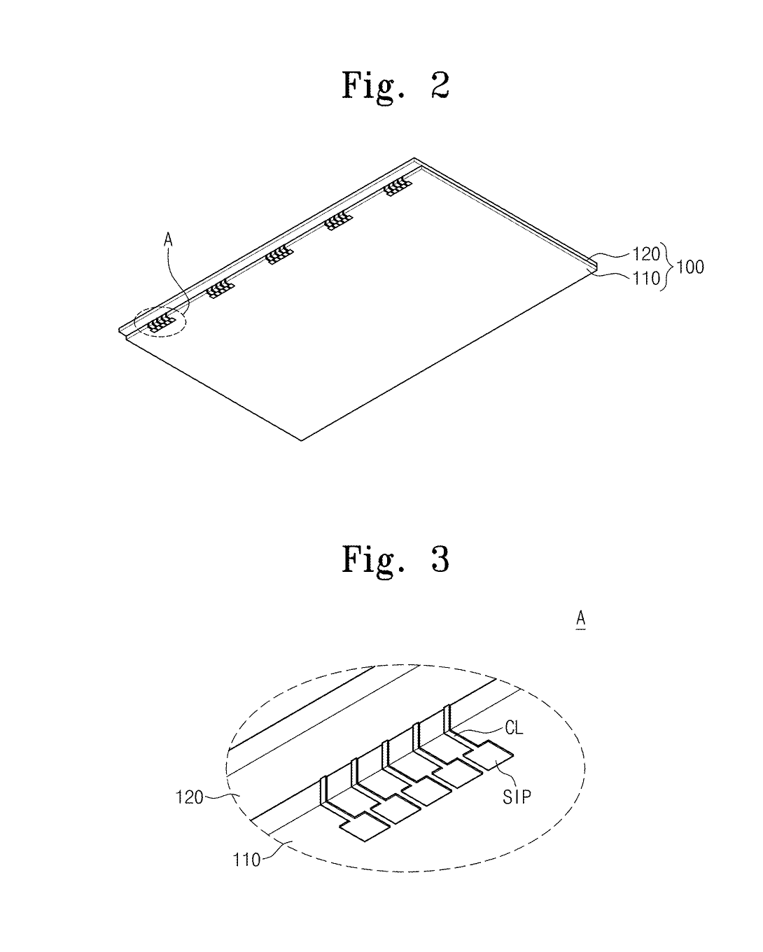

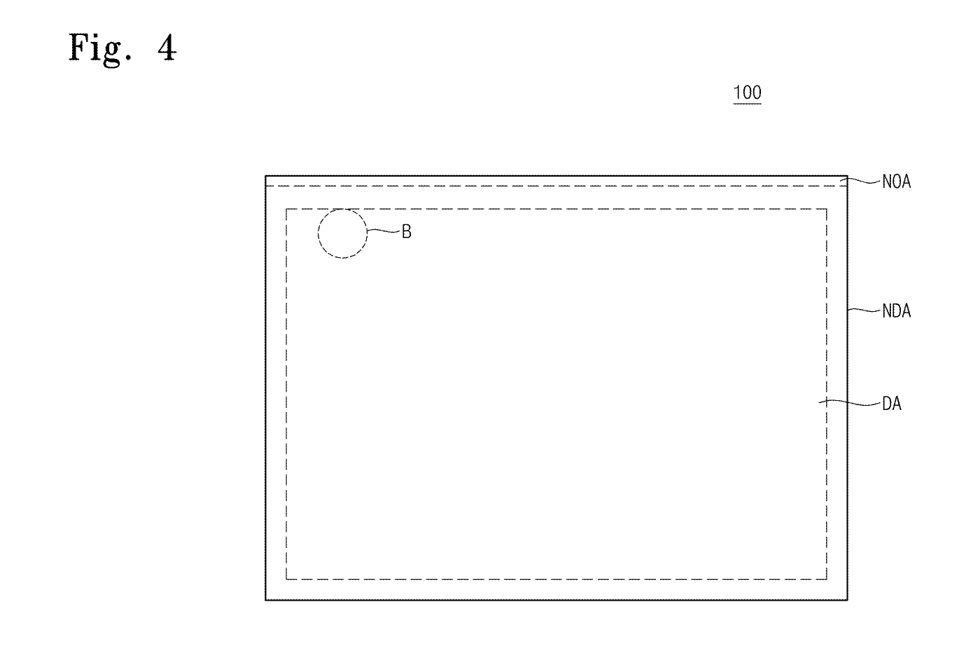

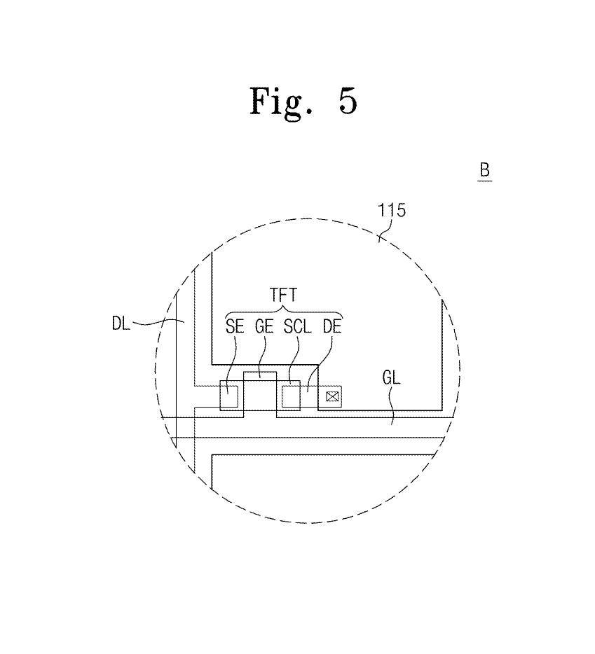

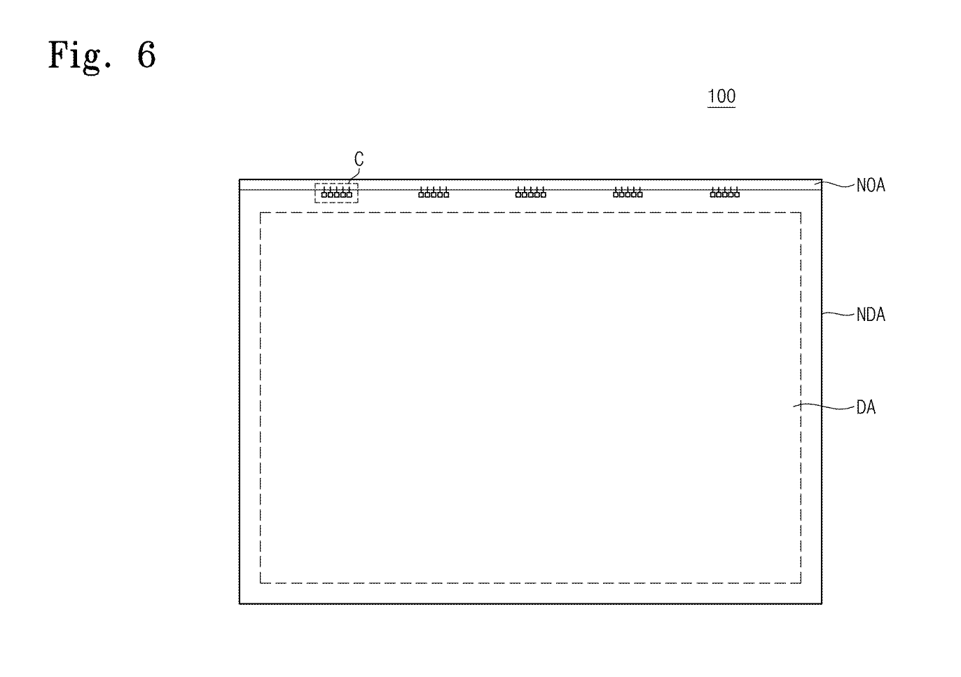

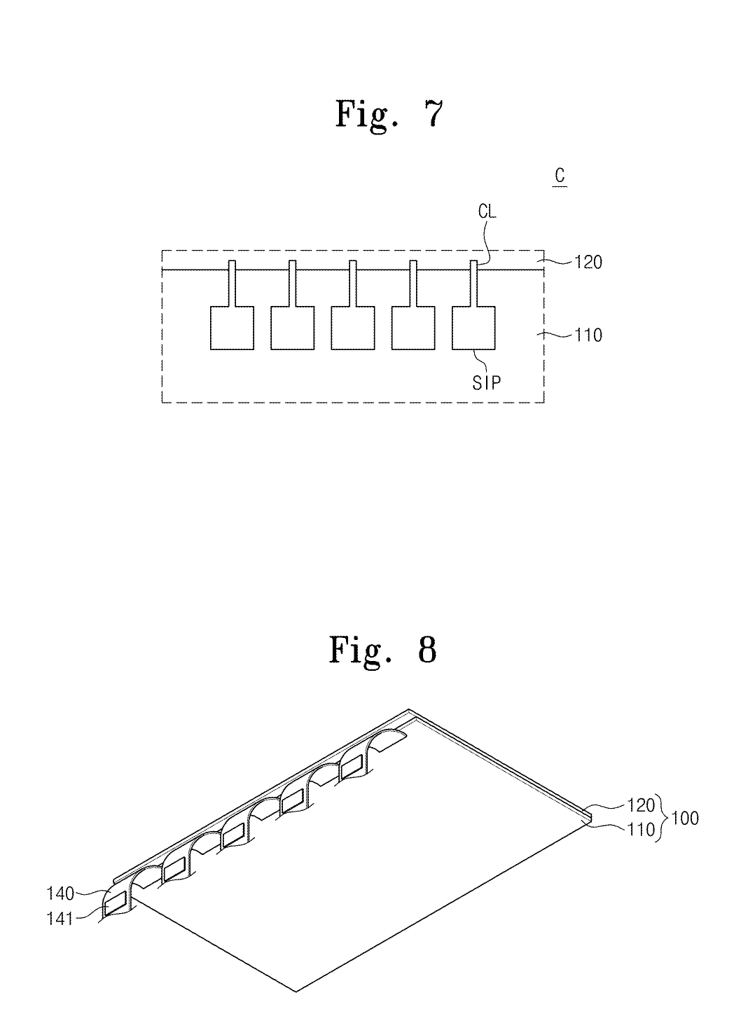

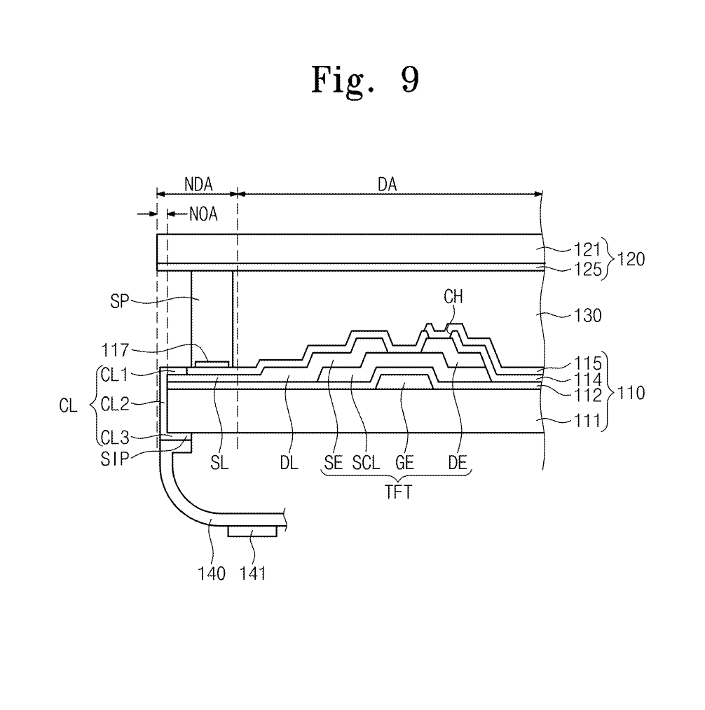

FIG. 2 is a lower perspective view of the display panel shown in FIG. 1, FIG. 3 is a partially enlarged view showing a portion A of FIG. 2, FIG. 4 is a plan view showing the display panel shown in FIG. 2, FIG. 5 is a partially enlarged view showing a portion B of FIG. 4, FIG. 6 is a rear plan view showing the display panel shown in FIG. 2, FIG. 7 is a partially enlarged view showing a portion C of FIG. 6, FIG. 8 is a lower perspective view showing a connection state between the display panel shown in FIG. 2 and a flexible printed circuit board, and FIG. 9 is a cross-sectional view showing a portion of the display panel shown in FIG. 8.

Referring to FIGS. 2 to 9, the display panel 100 includes the display area DA in which an image is displayed and the non-display area NDA disposed adjacent to the display area DA. The non-display area NDA surrounds the display area DA.

In addition, the display panel 100 includes the array substrate 110, the opposite substrate 120 facing the array substrate 110, the liquid crystal layer (not shown) interposed between the array substrate 110 and the opposite substrate 120, and the signal input pad SIP disposed on the outer surface of the array substrate 110 or the opposite substrate 120 in the non-display area NDA. For instance, the signal input pat SIP is disposed on the outer surface of the array substrate 110.

The array substrate 110 has a shape corresponding to that of the display panel 100, and thus the array substrate 110 includes the display area DA and the non-display area NDA. The pixels are arranged in the display area DA of the array substrate 110 in a matrix form, and each pixel includes a thin film transistor TFT and pixel electrode 115.

In detail, the array substrate 110 includes a first base substrate 111, thin film transistor TFTs disposed on the first base substrate 111 in the display area DA, and pixel electrodes 115 connected to respective TFTs.

The first base substrate 111 corresponds to the display area DA and the non-display area NDA and has a rectangular plate shape with long sides and short sides. In addition, the first base substrate 111 includes an upper surface facing the opposite substrate 120, a lower surface opposite to the upper surface, and a side surface connecting the upper surface and the lower surface.

The first base substrate 111 is formed of a transparent insulating material to transmit the light. In addition, the first base substrate 111 may be a rigid type substrate such as a glass substrate, a quartz substrate, a glass ceramic substrate, a crystalline glass substrate, etc., or a flexible type substrate such as a film substrate containing an organic polymer layer, a plastic substrate, etc. The materials used to form the first base substrate 111 have high heat-resistance when the first base substrate 111 is formed.

The thin film transistor TFT is disposed on the first base substrate 111 and includes a semiconductor layer SCL, a gate electrode GE, a source electrode SE, and a drain electrode DE. In detail, the thin film transistor TFT includes a gate electrode GE disposed on the first base substrate 111, a gate insulating layer 112 covering the gate electrode GE, a semiconductor layer SCL disposed on the gate insulating layer 112, and source and drain electrodes SE and DE connected to both ends of the semiconductor layer SCL. In the present exemplary embodiment, the semiconductor layer SCL includes a channel area overlapped with the gate electrode GE when viewed in a plan view, a source area making contact with the source electrode SE, and a drain area making contact with the drain electrode DE. The gate electrode GE of the thin film transistor TFT is connected to the gate line GL that transmits a scan signal or a gate signal to the thin film transistor TFT. The source electrode SE is connected to the data line DL that transmits the data voltage to the thin film transistor TFT.

As the above-mentioned thin film transistor, a bottom gate thin film transistor in which the gate electrode GE is disposed under the semiconductor layer SCL has been described, but the thin film transistor should not be limited to this configuration. That is, a top gate thin film transistor in which the gate electrode GE is disposed on the semiconductor layer SCL may be used as the above-mentioned thin film transistor TFT.

The thin film transistor TFT is electrically connected to the signal input pad SIP through a signal line SL. The signal line SL may be a gate line GL or a data line DL and may be extended into the non-display area NDA. When the signal input pad SIP is connected to a gate line GL, the signal input pad SIP may be a gate pad, and when the signal input pad SIP is connected to a data line DL, the signal input pad SIP may be a data pad.

The signal input pad SIP is disposed on the outer surface of the array substrate 110 or the opposite substrate 120. For instance, the signal input pad SIP is disposed on the outer surface of the array substrate 110, i.e., the lower surface of the first base substrate 111. In addition, the signal input pad SIP makes contact with the flexible printed circuit board 140 on which the driver IC 141 is mounted. The driver IC 141 receives the various control signals from the external circuit module and applies the driving signal used to drive the display panel 100 to the thin film transistor TFT through the signal input pad SIP in response to the various control signals.

The signal input pad SIP is electrically connected to the signal line SL by a connection line CL formed along the side surface of the first base substrate 111. In detail, the connection line CL includes a first portion CL1 disposed on the signal line SL, a second portion CL2 connected to the first portion CL1 and disposed on the side surface of the first base substrate 111, and a third portion CL3 disposed on the lower surface of the first base substrate 111 to connect the second portion CL2 and the signal input pad SIP.

Meanwhile, a protective layer 114 is disposed on the thin film transistor TFT. The protective layer 114 is provided with a contact hole CH formed therethrough to expose a portion of the drain electrode DE. In addition, the protective layer 114 may have a multi-layer structure. For instance, the protective layer 114 may include an inorganic protective layer to cover the thin film transistor TFT and the gate insulating layer 112 and an organic protective layer disposed on the inorganic protective layer. The organic protective layer removes a step-difference occurring due to the thin film transistor TFT to planarize an upper surface thereof.

The pixel electrode 115 is disposed on the protective layer 114 and electrically connected to the drain electrode DE through the contact hole CH. The pixel electrode 115 can be any transparent conductor, and in particular can include a transparent conductive oxide, such as indium tin oxide (ITO) or indium zinc oxide (IZO).

In the non-display area NDA, a common voltage pad 117 is disposed on the protective layer 114. The common voltage pad 117 makes contact with the seal pattern SP, which has conductive properties to allow a common voltage to be applied to a common electrode 125 of the opposite substrate 120. The common voltage pad 117 can be any transparent conductor, and in particular can include a transparent conductive oxide, such as indium tin oxide (ITO) or indium zinc oxide (IZO).

The seal pattern SP surrounds the display area DA to couple the array substrate 110 to the opposite substrate 120, and prevents liquid crystal molecules of the liquid crystal layer 130 from leaking.

The seal pattern SP may be, but is not limited to, an anisotropic conductive material having an insulating property in a first direction D1, e.g., a direction substantially parallel to the opposite substrate 120, and a conductive property in a second direction D2 perpendicular to the first direction D1, i.e. vertical. Accordingly, the seal pattern SP applies the common voltage to the common electrode 125 through the common voltage pad 117.

The opposite substrate 120 is disposed in the display area DA and the non-display area NDA and has an area equal to or greater than an area of the array substrate 110. The area of the opposite substrate 120 is substantially the same as the array substrate 110. Alternatively, in the case that the area of the opposite substrate 120 is greater than the area of the array substrate 110, a non-overlap area NOA exists between the opposite substrate 120 and the array substrate 110.

The opposite substrate 120 includes a second base substrate 121 and the common electrode 125 disposed on the second base substrate 121. The second base substrate 121 has an area equal to or greater than the area of the first base substrate 111. It is preferred that the area of the second base substrate 121 is substantially the same as the area of the first base substrate 111. In addition, the second base substrate 121 may be a rigid type substrate or a flexible type substrate similar to the first base substrate 111. The common electrode 125 can include a transparent conductive oxide as the pixel electrode 115. Further, the common electrode 125 applies the common voltage provided through the seal pattern SP to each pixel.

The liquid crystal layer 130 includes liquid crystal molecules. The liquid crystal molecules are arranged in specific directions by the electric field generated between the pixel electrode 115 and the common electrode 125, to control the transmittance of the light passing through the liquid crystal layer 130. Accordingly, the liquid crystal layer 130 transmits the light provided from the backlight unit 200 in response to the electric field, and thus the display panel 110 displays images.

As described above, the signal input pad SIP is disposed on the outer surface of the array substrate 110, i.e., the lower surface of the first base substrate 111, and the signal input pad SIP is electrically connected to the signal line SL through the connection line CL formed along the side surface of the first base substrate 111. Thus, the non-display area of the display panel 100 may be reduced. Since the non-display area NDA of the display panel 100 is reduced, a display apparatus employing the display panel 100 may reduce the space corresponding to the non-display area NDA in the upper and lower covers, which are prepared to accommodate the display panel 100.

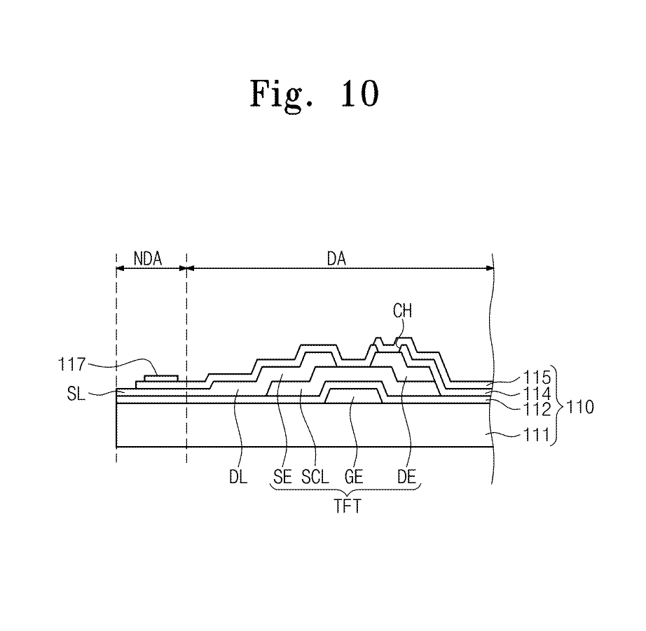

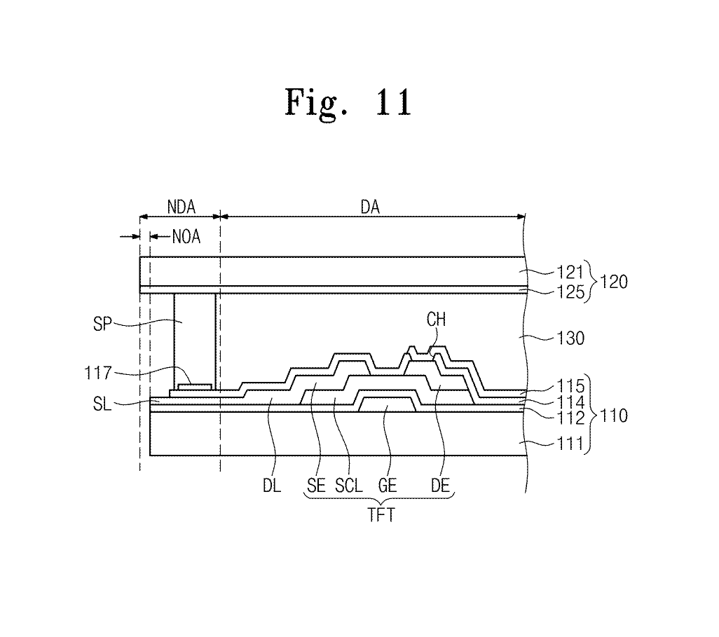

FIGS. 10 to 13 are cross-sectional views explaining a method of manufacturing the display panel shown in FIGS. 8 and 9.

Referring to FIG. 10, the array substrate 110 is manufactured. The array substrate 110 includes display area DA and non-display area NDA adjacent to the display area DA.

In addition, the array substrate 110 includes the first base substrate 111, the thin film transistor TFT disposed on the first base substrate 111, the pixel electrode 115 connected to the thin film transistor TFT, the signal line SL connected to the thin film transistor TFT and extended into the non-display area NDA, and the common voltage pad 117 disposed in the non-display area NDA.

Hereinafter, a method of manufacturing the array substrate 110 will be described in detail.

The first base substrate 111 is prepared. The first base substrate 111 transmits light therethrough and has a rectangular plate shape with long sides and short sides. The first base substrate 111 includes an upper surface, a lower surface facing the upper surface, and side surfaces connecting the upper surface and the lower surface. In addition, the first base substrate 111 is disposed in the display area DA and the non-display area NDA.

When the first base substrate 111 is prepared, the thin film transistor TFT is formed on the first base substrate 111. The thin film transistor TFT includes the gate electrode GE, the semiconductor layer SCL, the source electrode SE, and the drain electrode DE.

To form the thin film transistor TFT, the gate electrode GE is formed on the first base substrate 111 and the gate insulating layer 112 is formed on the first base substrate 111 to cover the gate electrode GE. Then, the semiconductor layer SCL is formed on the gate insulating layer 112, and the source electrode SE and the drain electrode DE are formed on the semiconductor layer SCL to be respectively connected to the source area and the drain area of the semiconductor layer SCL. The area of the semiconductor layer SCL between the source area and the drain area serves as a channel area. In addition, the signal line SL is formed in the non-display area NDA together with the source and drain electrodes SE and DE. The signal line SL may be formed by extending the data line connected to the source electrode SE to the non-display area NDA.

After the thin film transistor TFT is formed, the protective layer 114 is formed to cover the thin film transistor TFT. The protective layer 114 includes the inorganic material, the organic material, or a compound of organic and inorganic materials.

Then, the protective layer 114 is patterned to remove a portion thereof, and thus the contact hole CH is formed to expose a portion of the drain electrode DE. A portion of the protective layer 114 in the non-display area NDA is also removed when the contact hole CH is formed, thereby exposing a portion of the signal line SL that is connected to the thin film transistor TFT.

When the portion of the drain electrode DE is exposed, the transparent conductive oxide is deposited and patterned. Due to the patterning process, the pixel electrode 115 is formed in the display area DA to be connected to the drain electrode DE of the thin film transistor TFT through the contact hole CH. In addition, the common voltage pad 117 is formed in the non-display area NDA by the patterning process.

Referring to FIG. 11, after the array substrate 110 is formed, the seal pattern SP is disposed in the non-display area NDA of the array substrate 110. That is, the seal pattern SP surrounds the display area DA and is overlapped with the common voltage pad 117.

The seal pattern SP may be, but is not limited to, an anisotropic conductive material having an insulating property in the first direction D1, e.g., the direction substantially parallel to the opposite substrate 120, and a conductive property in the second direction D2 perpendicular to the first direction D1.

Then, the liquid crystal layer 130 including liquid crystal molecules is disposed in the display area DA.

Next, the opposite substrate 120, that includes the second base substrate 121 and the common electrode 125 disposed on the second base substrate 121, is prepared.

The opposite substrate 120 is disposed in the display area DA and the non-display area NDA, and has the area equal to or greater than the area of the array substrate 110. The area of the opposite substrate 120 is substantially the same as the array substrate 110. Alternatively, in the case that the area of the opposite substrate 120 is greater than the area of the array substrate 110, the non-overlap area NOA exists between the opposite substrate 120 and the array substrate 110.

The opposite substrate 120 includes the second base substrate 121 and the common electrode 125 disposed on the second base substrate 121. The second base substrate 121 has an area equal to or greater than the area of the first base substrate 111. It is preferred that the area of the second base substrate 121 is substantially the same as the area of the first base substrate 111. In addition, the second base substrate 121 may be a rigid type substrate or a flexible type substrate similar to the first base substrate 111. The common electrode 125 includes the same transparent conductive oxide as the pixel electrode 115.

Then, the opposite substrate 120 is disposed such that the common electrode 125 faces the array substrate 110. The array substrate 110 and the opposite substrate 120 are coupled to each other by the seal pattern SP. As described above, since the seal pattern SP is disposed to surround the display area DA and couples the array substrate 110 to the opposite substrate 120, the liquid crystal molecules of the liquid crystal layer 130 may be prevented from leaking.

The seal pattern SP makes contact with the common electrode 125 of the opposite substrate 120. Accordingly, the seal pattern SP is applied with the common voltage through the common voltage pad 117 to apply the common voltage to the common electrode 125. The common electrode 125 applies the common voltage to each pixel.

In the present exemplary embodiment, the liquid crystal layer 130 is formed after the seal pattern SP is formed, and then the array substrate 110 is coupled to the opposite substrate 120, but they should not be limited thereto or thereby. For instance, the liquid crystal layer 130 may be formed by forming the seal pattern SP, coupling the array substrate 110 to the opposite substrate 120, and injecting the liquid crystal molecules between the array substrate 110 and the opposite substrate 120.

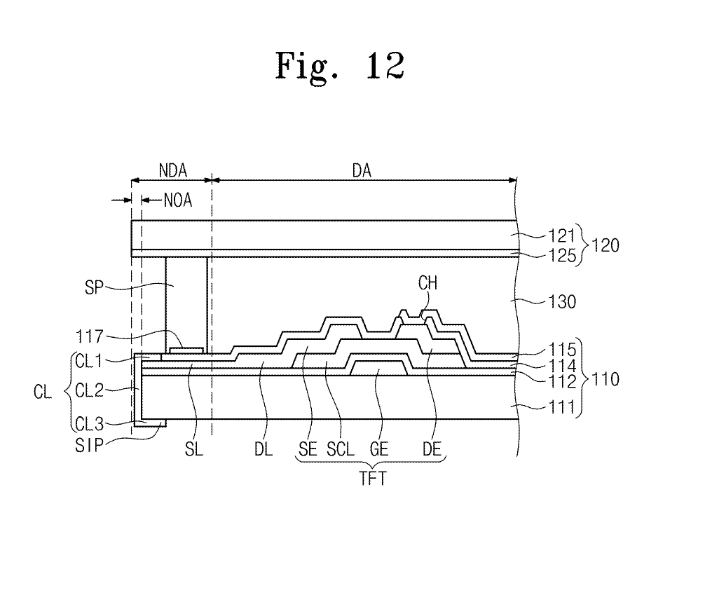

Referring to FIG. 12, when the array substrate 110 is coupled to the opposite substrate 120, the signal input pad SIP and the connection line CL are formed.

The signal input pad SIP is formed on the outer surface of the array substrate 110, i.e., on the lower surface of the first base substrate 111.

As described above, the connection line CL connects the signal line SL to the signal input pad SIP along the side surface of the first base substrate 111. In detail, the connection line CL includes first portion CL1 disposed on the signal line SL, second portion CL2 connected to the first portion CL1 and disposed on the side surface of the first base substrate 111, and third portion CL3 disposed on the lower surface of the first base substrate 111 to connect the second portion CL2 and the signal input pad SIP.

In the present exemplary embodiment, the signal input pad SIP and the connection line CL may be substantially and simultaneously formed by an aerosol jet printing method.

Different from a conventional inkjet printing method, the aerosol jet printing method is used to form electrical wirings having superior conductivity. To this end, the ink is atomized by using carrier gas sprayed at high speed, and the atomized ink is sprayed to a surface of the substrate to form a metal ink. Then, when the metal ink is sintered by a laser, electrical wirings having superior conductivity are formed. In addition, since the aerosol jet printing method is a non-contact pattern forming method, damage to the substrate is reduced when compared to the conventional inkjet printing method.

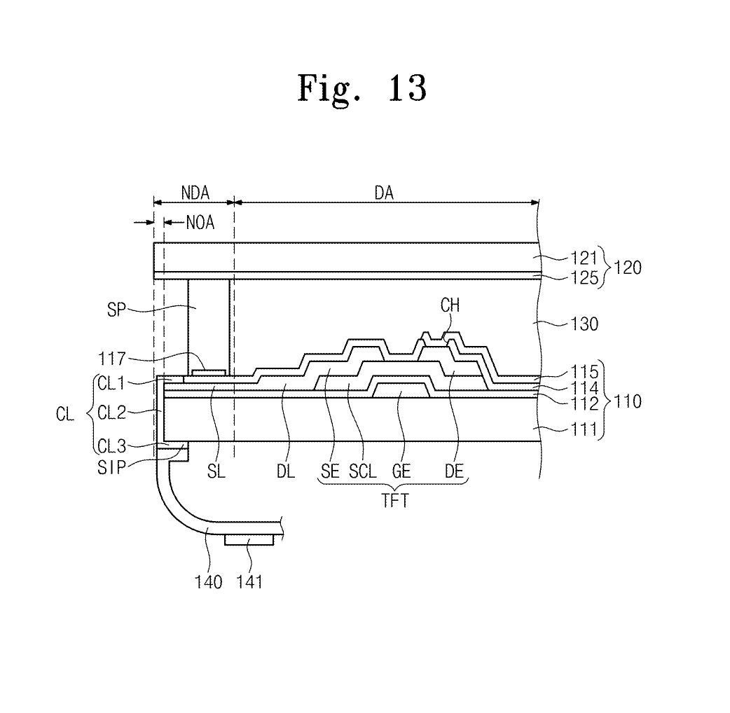

Referring to FIG. 13, after the connection line CL and the signal input pad SIP are formed, the flexible printed circuit board 140 (on which the driver IC 141 is mounted) is attached to the signal input pad SIP.

In the display panel manufactured by the above-mentioned processes, the signal input pad SIP is disposed on the outer surface of the array substrate 110, i.e., on the lower surface of the first base substrate 111 and is electrically connected to the signal line SL through the connection line CL formed along the side surface of the first base substrate 111. That is, the signal input pads SIP are located on the outer surface of substrate 110 rather than being located on the opposite surface, thus increasing the amount of components in the non-display area NDA of the opposite surface. Thus, the non-display area NDA of the display panel may be reduced. As described above, since the non-display area NDA of the display panel 100 is reduced, a display apparatus employing the display panel 100 may reduce the space corresponding to the non-display area NDA in the upper and lower covers.

Finally, the display panel is accommodated in the upper and lower covers together with the backlight unit, so that the display apparatus is manufactured.

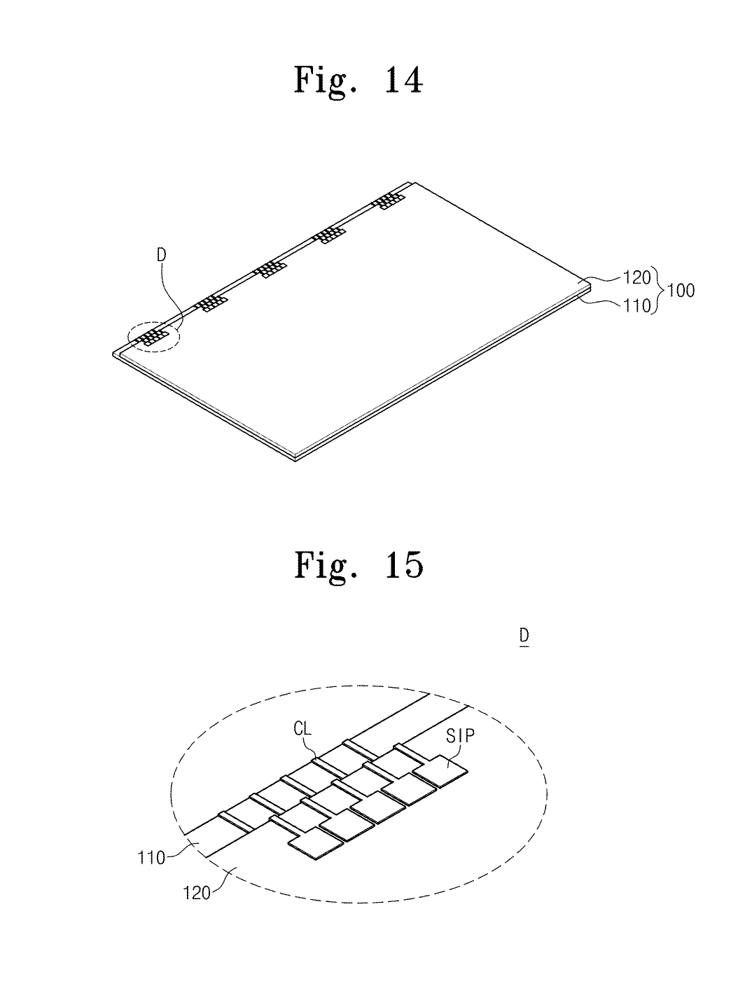

Hereinafter, a display panel according to another exemplary embodiment will be described in detail with reference to FIGS. 14 to 22. In FIGS. 14 to 22, the same reference numerals denote the same elements in FIGS. 1 to 13, and thus detailed descriptions of the same elements will be omitted in order to avoid redundancy.

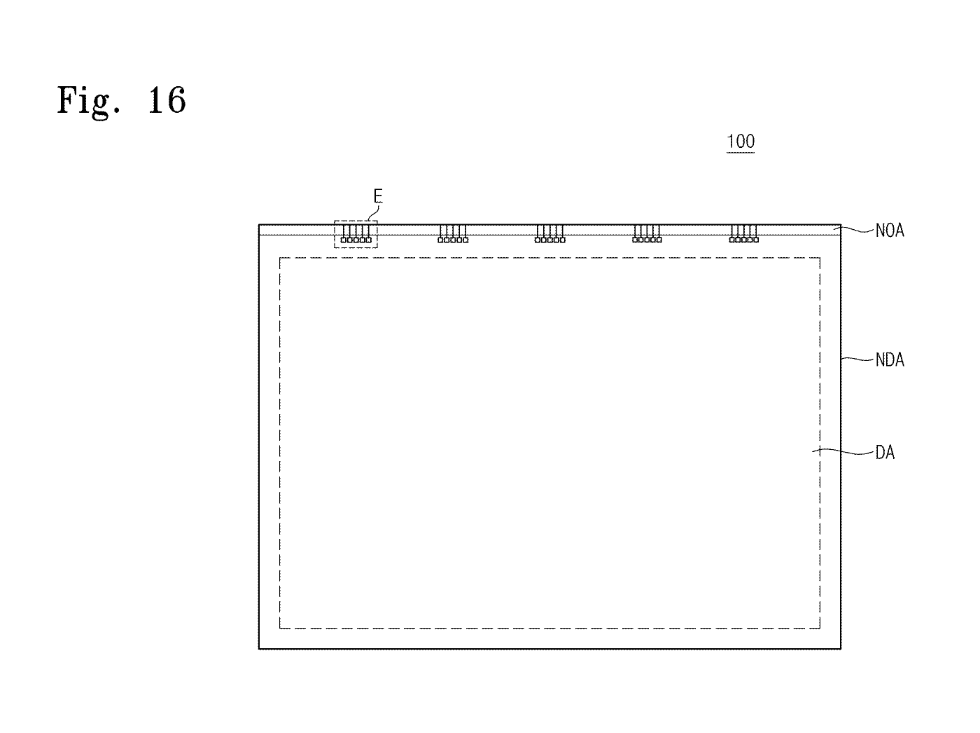

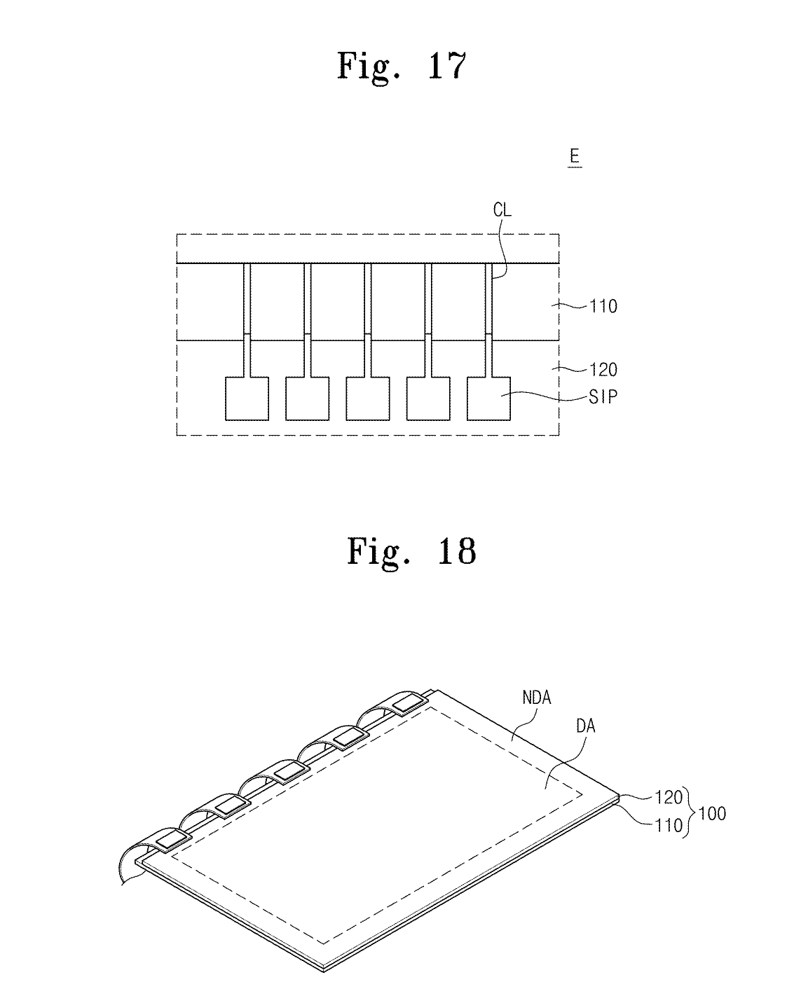

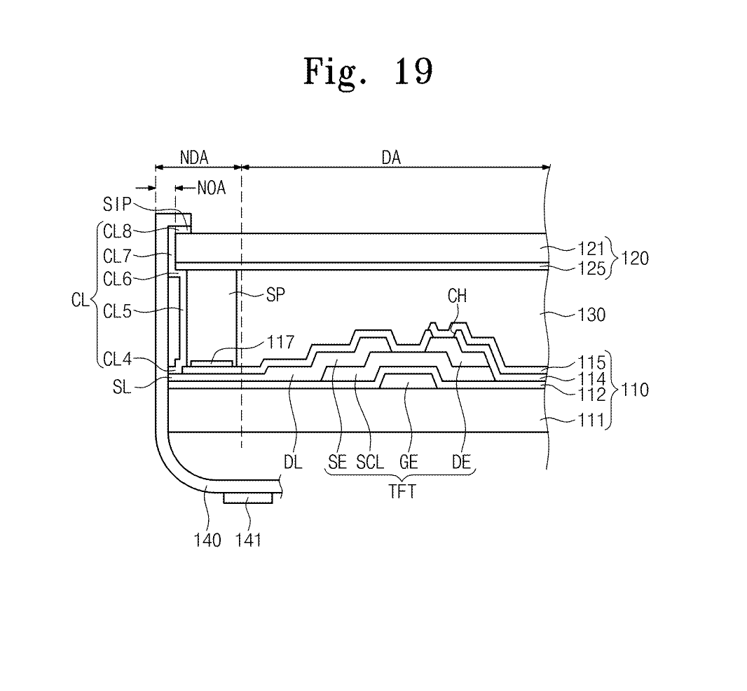

FIG. 14 is a perspective view showing a display panel according to another exemplary embodiment of the present invention, FIG. 15 is a partially enlarged view showing a portion D of FIG. 14, FIG. 16 is a plan view showing the display panel shown in FIG. 14, FIG. 17 is a partially enlarged view showing a portion E of FIG. 16, FIG. 18 is a perspective view showing a connection state between the display panel shown in FIG. 14 and a flexible printed circuit board, and FIG. 19 is a cross-sectional view showing the display panel shown in FIG. 18.

Referring to FIGS. 14 to 19, a display panel 100 includes a display area DA and a non-display area NDA surrounding the display area DA.

The display panel 100 includes an array substrate 110, an opposite substrate 120 facing the array substrate 110, a liquid crystal layer 130 disposed between the array substrate 110 and the opposite substrate 120, and a signal input pad SIP disposed on the outer surface of the array substrate 110 or the opposite substrate 120 to correspond to the non-display area NDA. For instance, the signal input pad SIP may be disposed on the outer surface of the opposite substrate 120.

The array substrate 110 has a shape corresponding to that of the display panel 100, and thus includes display area DA and non-display area NDA. In addition, the array substrate 110 includes a first base substrate 111, a thin film transistor TFT disposed on the upper surface of the first base substrate 111, and a pixel electrode 115 connected to the thin film transistor TFT.

The first base substrate 111 is disposed in the display area DA and the non-display area NDA and has a rectangular plate shape with long sides and short sides. In addition, the first base substrate 111 includes an upper surface facing the opposite substrate 120, a lower surface opposite to the upper surface, and a side surface connecting the upper surface and the lower surface.

The thin film transistor TFT is disposed on the first base substrate 111 and includes a semiconductor layer SCL, a gate electrode GE, a source electrode SE, and a drain electrode DE. The source electrode SE is connected to the data line DL that applies the data voltage to the thin film transistor TFT.

The thin film transistor TFT is electrically connected to the signal input pad SIP through the signal line SL. The signal line SL may be the gate line GL or the data line DL. In the present exemplary embodiment, in the case that the signal input pad SIP is connected to the gate line GL, the signal input pad SIP may be the gate pad. In addition, in the case that the signal input pad SIP is connected to the data line DL, the signal input pad SIP may be the data pad.

A protective layer 114 is disposed on the thin film transistor TFT. The protective layer 114 is partially opened to form a contact hole CH through which a portion of the drain electrode DE is exposed.

The pixel electrode 115 is disposed on the protective layer 114 and is electrically connected to the drain electrode DE through the contact hole CH.

The opposite substrate 120 includes the display area DA and the non-display area NDA, and has an area equal to or smaller than an area of the array substrate 110. The area of the opposite substrate 120 can be substantially the same as the array substrate 110. Alternatively, in the case that the area of the opposite substrate 120 is smaller than the area of the array substrate 110, a non-overlap area NOA exists between the opposite substrate 120 and the array substrate 110.

The opposite substrate 120 includes a second base substrate 121 and the common electrode 125 disposed on the second base substrate 121. The second base substrate 121 has an area equal to or smaller than the area of the first base substrate 111. It is preferred that the area of the second base substrate 121 is substantially the same as the area of the first base substrate 111. In addition, the second base substrate 121 includes a lower surface facing the array substrate 110, an upper surface opposite to the lower surface, and a side surface connecting the lower surface and the upper surface.

A seal pattern SP is disposed between the array substrate 110 and the opposite substrate 120 to correspond to the non-display area NDA. The seal pattern SP is conductive, and makes contact with a common voltage pad 117, so that a common voltage is applied to the common electrode 125 of the opposite substrate 120 through the seal pattern SP.

The signal input pad SIP is disposed on the outer surface of the opposite substrate 120 in the non-display area NDA, i.e., on the upper surface of the second base substrate 121. In addition, the signal input pad SIP is connected to a flexible printed circuit board 140 on which a driver IC is mounted.

The signal input pad SIP is electrically connected to the signal line SL through a connection line CL formed along the side surface of the second base substrate 121. In detail, the connection line CL includes a fourth portion CL4 disposed on the signal line SL, a fifth portion CL5 connected to the fourth portion CL4 and disposed on the outer surface of the seal pattern SP, a sixth portion CL6 connected to the fifth portion CL5 and disposed on the lower surface of the second base substrate 121, a seventh portion CL7 connected to the sixth portion CL6 and disposed on the side surface of the second base substrate 121, and an eighth portion CL8 disposed on the upper surface of the second base substrate 121 to connect the seventh portion CL7 and the signal input pad SIP.

As described above, the signal input pad SIP is disposed on the outer surface of the opposite substrate 120, i.e., on the upper surface of the second base substrate 121, and the signal input pad SIP is electrically connected to the signal line SL through the connection line CL formed along the side surface of the second base substrate 121. Thus, the non-display area NDA of the display panel 100 may be reduced. Since the non-display area NDA of the display panel 100 is reduced, the display apparatus employing the display panel 100 may reduce the space corresponding to the non-display area NDA in the upper and lower covers, which are prepared to accommodate the display panel 100.

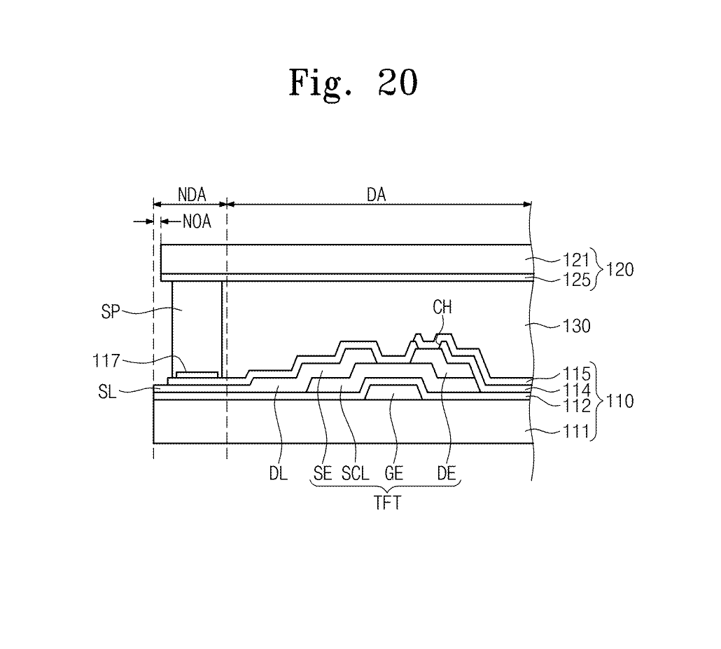

FIGS. 20 to 22 are cross-sectional views explaining a method of manufacturing the display panel shown in FIGS. 18 and 19.

Referring to FIG. 20, the array substrate 110 and the opposite substrate 120 are prepared and coupled to each other using the seal pattern SP.

The array substrate 110 includes first base substrate 111, thin film transistor TFT disposed on the first base substrate 111, pixel electrode 115 connected to the thin film transistor TFT, signal line SL connected to the thin film transistor TFT and extending into the non-display area NDA, and common voltage pad 117 disposed on the non-display area NDA.

The opposite substrate 120 includes display area DA and non-display area NDA, and has an area equal to or smaller than the area of the array substrate 110. The area of the opposite substrate 120 is substantially the same as the array substrate 110. Alternatively, in the case that the area of the opposite substrate 120 is smaller than the area of the array substrate 110, non-overlap area NOA exists between the opposite substrate 120 and the array substrate 110.

The opposite substrate 120 includes second base substrate 121 and common electrode 125 disposed on the second base substrate 121. The second base substrate 121 has an area equal to or smaller than the area of the first base substrate 111. It is preferred that the area of the second base substrate 121 is substantially the same as the area of the first base substrate 111. In addition, the second base substrate 121 includes a lower surface facing the array substrate 110, an upper surface opposite to the lower surface, and a side surface connecting the lower surface and the upper surface.

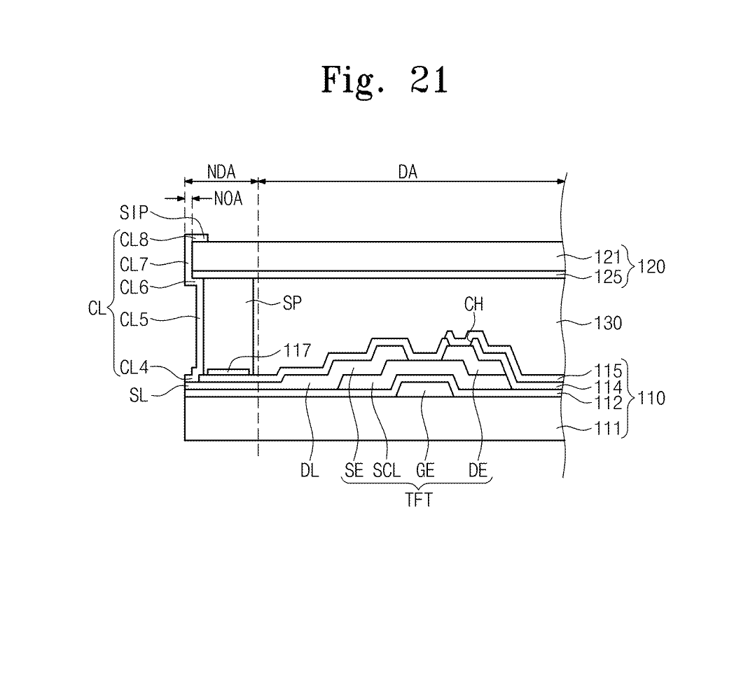

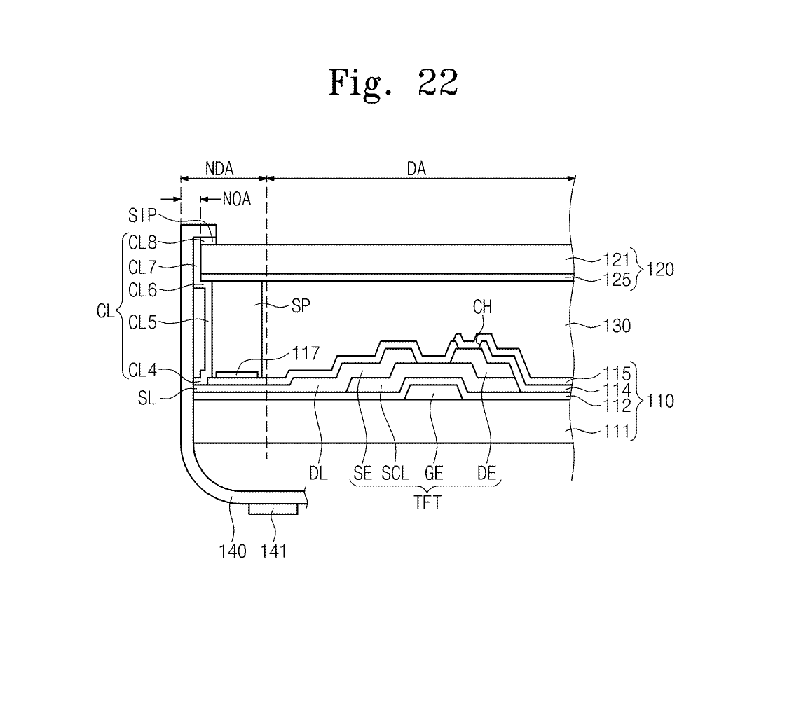

Referring to FIG. 21, after the array substrate 110 and the opposite substrate 120 are coupled to each other, the signal input pad SIP electrically connected to the signal line SL, and the connection line CL connecting the signal line to the signal input pad SIP, are formed.

The signal input pad SIP is formed on the outer surface of the opposite substrate 120, i.e., on the upper surface of the second base substrate 121. In addition, the connection line CL includes fourth portion CL4 disposed on the signal line SL, fifth portion CL5 connected to the fourth portion CL4 and disposed on the outer surface of the seal pattern SP, sixth portion CL6 connected to the fifth portion CL5 and disposed on the lower surface of the second base substrate 121, seventh portion CL7 connected to the sixth portion CL6 and disposed on the side surface of the second base substrate 121, and eighth portion CL8 disposed on the upper surface of the second base substrate 121 to connect the seventh portion CL7 and the signal input pad SIP.

In the present exemplary embodiment, the signal input pad SIP and the connection line CL may be substantially and simultaneously formed by an aerosol jet printing method.

Referring to FIG. 22, after the connection line CL and the signal input pad SIP are formed, the flexible printed circuit board 140 on which the driver IC 141 is mounted is attached to the signal input pad SIP.

Then, when the display panel 100 and the backlight unit are accommodated in the space between the upper cover and the lower cover, the display apparatus is manufactured.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display panel comprising:
an array substrate including a display area having a pixel, and a non-display area adjacent to the display area;
an opposite substrate facing the array substrate;
a liquid crystal layer disposed between the array substrate and the opposite substrate; and
a signal input pad electrically connected to the pixel so as to be configured to apply an external input signal to the pixel;
wherein each of the array substrate and the opposite substrate has an inner surface facing the liquid crystal layer and an outer surface opposite to the respective inner surface, and wherein the signal input pad is disposed on the outer surface of either the array substrate or the opposite substrate.

2. The display panel of claim 1, wherein the array substrate comprises:
a first base substrate disposed over the display area and the non-display area and including an upper surface facing the opposite substrate, a lower surface opposite to the upper surface, and a side surface connecting the upper surface and the lower surface;
a thin film transistor disposed on the upper surface of the first base substrate in the non-display area;
a pixel electrode connected to the thin film transistor; and
a signal line connected to the thin film transistor, extending into the non-display area, and electrically connected to the signal input pad.

3. The display panel of claim 2, further comprising a connection line connecting the signal line and the signal input pad.

4. The display panel of claim 3, wherein the signal input pad is disposed on the lower surface of the first base substrate.

5. The display panel of claim 4, wherein the connection line comprises:
a first portion in electrical communication with the signal line;
a second portion connected to the first portion and disposed on the side surface of the first base substrate; and
a third portion disposed on the lower surface of the first base substrate to connect the second portion and the signal input pad.

6. The display panel of claim 4, wherein the opposite substrate has a surface area equal to or greater than a surface area of the array substrate.

7. The display panel of claim 3, wherein the opposite substrate comprises:
a second base substrate disposed over the display area and the non-display area and including a lower surface facing the array substrate, an upper surface opposite to the lower surface, and a side surface connecting the upper surface and the lower surface; and
a common electrode disposed on the lower surface of the second base substrate.

8. The display panel of claim 7, wherein the signal input pad is disposed on the upper surface of the second base substrate.

9. The display panel of claim 8, further comprising a seal pattern disposed in the non-display area to surround the display area and to electrically couple the array substrate to the opposite substrate.

10. The display panel of claim 9, wherein the connection line comprises:
a fourth portion electrically connected to the signal line;
a fifth portion connected to the fourth portion and disposed on an outer surface of the seal pattern;
a sixth portion connected to the fifth portion and disposed on the lower surface of the second base substrate;
a seventh portion connected to the sixth portion and disposed on the side surface of the second base substrate; and
an eighth portion disposed on the upper surface of the second base substrate to connect the seventh portion and the signal input pad.

11. The display panel of claim 8, wherein the opposite substrate has a surface area equal to or smaller than that of the array substrate.

12. A method of manufacturing a display panel, comprising:
preparing an array substrate having a display area and a non-display area adjacent to the display area and including a first base substrate, a thin film transistor disposed on the first base substrate in the display area, and a signal line connected to the thin film transistor and extending into the non-display area;
coupling an opposite substrate to the array substrate using a seal pattern disposed in the non-display area, the opposite substrate being disposed over the display area and the non-display area; and
forming a signal input pad electrically connected to the signal line;
wherein each of the array substrate and the opposite substrate has an inner surface facing the seal pattern and an outer surface opposite to the respective inner surface, and wherein the signal input pad is disposed on the outer surface of either the array substrate or the opposite substrate.

13. The method of claim 12, wherein the first base substrate comprises:
an upper surface facing the opposite substrate;
a lower surface opposite to the upper surface; and
a side surface connecting the upper surface and the lower surface, and the signal input pad is disposed on the lower surface of the first base substrate.

14. The method of claim 13, further comprising forming a connection line electrically connecting the signal line to the signal input pad, wherein the connection line comprises:
a first portion in electrical communication with the signal line;
a second portion connected to the first portion and disposed on the side surface of the first base substrate; and
a third portion disposed on the lower surface of the first base substrate to connect the second portion and the signal input pad.

15. The method of claim 14, wherein the forming a signal input pad and the forming a connection line collectively comprise forming the signal input pad and the connection line using an aerosol jet method.

16. The method of claim 13, wherein the opposite substrate has a surface area equal to or greater than a surface area of the array substrate.

17. The method of claim 12, wherein the opposite substrate comprises:
a second base substrate that includes a lower surface facing the array substrate, an upper surface opposite to the lower surface, and a side surface connecting the lower surface and the upper surface; and
a common electrode disposed on the lower surface of the second base substrate, wherein the signal input pad is disposed on the upper surface of the second base substrate.

18. The method of claim 17, further comprising forming a connection line electrically connecting the signal line to the signal input pad, wherein the connection line comprises:
a fourth portion in electrical communication with the signal line;
a fifth portion connected to the fourth portion and disposed on an outer surface of the seal pattern;
a sixth portion connected to the fifth portion and disposed on the lower surface of the second base substrate;
a seventh portion connected to the sixth portion and disposed on the side surface of the second base substrate; and
an eighth portion disposed on the upper surface of the second base substrate to connect the seventh portion and the signal input pad.

19. The method of claim 18, wherein the forming a signal input pad and the forming a connection line collectively comprise forming the signal input pad and the connection line using an aerosol jet method.

20. The method of claim 17, wherein the opposite substrate has a surface area equal to or smaller than a surface area of the array substrate.
